(19) United States
(12) Patent Application Publication
(10) Pub. No.: US 2023/0078254 A1
(43) Pub. Date: Mar. 16, 2023

(54) SYSTEM AND METHOD FOR TRANSMITTING COVERT WIRELESS SIGNALS WITHIN AN OVERT WIRELESS SIGNAL TRANSMISSION

(71) Applicant: The Research Foundation for the State University of New York, Albany, NY (US)

(72) Inventors: Dola Saha, Albany, NY (US); Hesham Mohammed, Albany, NY (US)

(21) Appl. No.: 17/945,508

(22) Filed: Sep. 15, 2022

Related U.S. Application Data
(60) Provisional application No. 63/244,393, filed on Sep. 15, 2021.

(51) Int. Cl. H04K 1/02

(52) U.S. Cl. CPC H04K 1/02

(57) ABSTRACT

A system and method for transmitting, from an encoder to a decoder, one or more covert wireless signals within an overt wireless signal. The encoder receives a bitstream and encodes the received bitstream into an encoded noise signal that replicates a noise signal of a predetermined hardware device. The encoded noise signal is then combined with a cover modulated signal to form at least one covert wireless signal that is distinct from and conceals the received bitstream. The covert wireless signal is transmitted within an overt wireless signal to a decoder that receives the covert wireless signal, removes the cover modulated signal from the received covert wireless signal to isolate the encoded noise signal, and then converts the isolated encoded noise signal into a decoded bitstream. The covert wireless signal can be a plurality of carrier signals, optionally established through orthogonal frequency-division multiplexing (OFDM) or quadrature amplitude modulation (QAM).

### CROSS-REFERENCE TO RELATED APPLICATION

This application claims the benefit of U.S. Provisional Patent Application No. 63/244,393, filed on Sep. 15, 2021, the entirety of which is hereby incorporated herein by this reference.

### BACKGROUND OF THE INVENTION

### 1. Field of the Invention

The present invention generally relates to transmission and receipt of wireless signals. More particularly, to systems and methods for concealing high-capacity covert wireless signals within an active, overt wireless signal, with the covert-signal receiver being trained with active learning techniques.

### 2. Description of the Related Art

As coexistence of frequency-agile, heterogeneous and cognitive nodes becomes a norm in the next generation (xG) wireless networks, the electromagnetic environment (EME) becomes congested, contested and competitive. Potential adversaries will seek opportunities to decipher critical information transmitted in open signals over the air. Although cryptography exists in the higher layers as an add-on feature, there exist several vulnerabilities in the physical layer that can expose critical information over the air. Jamming, spectrum poisoning, and signal spoofing are some of the attacks, which can be launched in the physical layer to intercept the data or launch impersonation attack or denial of service. Signal disruption is even more crucial in electronic warfare, where the existence of a communication between two radios may raise concerns. Hence, in critical scenarios, to avoid any such attacks, one strategy is to obfuscate a wireless signal such that it reaches the intended receiver without it being detected by a third party.

Military communications will often rely on signals with low probability of intercept (LPI) or a low probability of detection (LPD) in hostile environment. However, these signals typically suffer from low capacity of the communication link, especially when the signal needs to be hidden under a “noise floor” to minimize the probability of detection. It is also known to hide the presence of a secret, covert signal within another overt cover signal, a term widely known as “wireless steganography” or covert communication. Steganography is an early technique to hide secret information within other overt information, which can be image, text, audio or video.

Major benefits of using wireless signals for steganographic, covert communication over other forms of information is that the covert signal can only be captured over-the-air in the vicinity of the covert transmitter, and the covert signals are not stored and transitory. With attention paid solely to the overt carrier signal, there is no recordation or storage of the covert signal communication. Despite the advantage of placing covert signals in an overt signal, there are several disadvantages to using this method of communication.

Many of the steganographic wireless signal techniques suffer from low data capacity of the secret channel. There have been attempts to increase data capacity by using machine learning algorithms which have enabled image steganography that can hide a secret image of the same size as the cover image, but this technique in the image domain has not been extrapolated to the wireless domain due to the fundamental difference in data type. Furthermore, wireless steganography is normally limited to modifying the signal within the limits of various wireless standards to hide the signal. When the signal is decoded according to the standards, the covert message would not be revealed. However, many of these techniques will still reveal presence of an anomaly in the transmitted signal if steganalysis is performed on all data sent in the overt signal domain. It is to address the problems with the prior art of embedding covert signals in an overt wireless signal transmission that that present invention is primarily directed.

### BRIEF SUMMARY OF THE INVENTION

Briefly described, the present invention provides a system and method for transmitting, from an encoder to a decoder, one or more covert wireless signals within an overt wireless signal. The encoder receives a bitstream and encodes the received bitstream into an encoded noise signal that replicates a noise signal of a predetermined hardware device. The encoded noise signal is then combined with a cover modulated signal to form at least one covert wireless signal that is distinct from and conceals the received bitstream. The covert wireless signal is transmitted within an overt wireless signal to a decoder that receives the covert wireless signal, removes the cover modulated signal from the received covert wireless signal to isolate the encoded noise signal, and then converts the isolated encoded noise signal into a decoded bitstream. The decoder can, but does not have to, receive the overt wireless signal and/or act upon it.

The system and method can include a critic module operably coupled to the encode that compares the encoded noise signal generated by the encoder and the noise signal of the predetermined hardware device, and determines statistical properties for each of the encoded noise signal and the noise signal of the predetermined hardware device. The predetermined hardware device can be any device that is known to introduce an amount of noise in a wireless signal transmission. The encoder can be further configured to adjust characteristics of the encoded noise signal in response to the critic module determining that the statistical properties for the encoded noise signal differ from the statistical properties of the noise signal of the predetermined hardware device.

In one embodiment, each of the encoder and the decoder includes a multi-node neural network. Other types of AI or other expert systems can be used for each of the encoder and decoder. In such embodiment, the encoder can be further configured to transmit the original bitstream to the decoder for a predetermined training session such that the decoder will receive the bitstream from the encoder during the training session, and compare the received bitstream with the decoded bitstream to thereby determine a decoding accuracy. The decoder can relay the decoding accuracy to the encoder and thus train the system to increase accuracy in receipt and reveal of the contents of the one or more covert wireless signals

Furthermore, the covert wireless signal can be a plurality of carrier signals, optionally established through orthogonal frequency-division multiplexing (OFDM) or quadrature amplitude modulation (QAM). And the covert signal(s) can also be encrypted depending on the embodiment.

The encoded noise signal can be within a transmission bandwidth defined by at least one predetermined regulatory communication standard, such as those for mobile, wireless, or network communication bandwidths. For instance, most wireless standards provide acceptable range of error for operation. Thus, the covert signal(s) containing the covert message (in bits) will appear to mimic the distribution of a noise (complex signal) generated from any wireless radio hardware such that a steganalysis on this covert signal will not be able to differentiate whether the source of the noise is the transmitter frontend or there is an underlying covert communication.

The present invention therefore provides an advantage is that it can provide high-bandwidth covert wireless signals in steganographic wireless signal techniques Furthermore, the present invention allows wireless steganography that can exceed the data channel within various wireless standards because it can also utilize known channels of noise. The invention also has an industrial application in providing a novel encoder and decoder that can communicate over the one or more covert wireless channels.

### BRIEF DESCRIPTION OF THE DRAWINGS

FIG. 1 is a pictorial diagram of a high-bandwidth covert side-channel between multiple radios using a common wireless network.

FIG. 2A shows a graph representing hardware noise.

FIG. 2B shows a schematic view of a system for hiding covert wireless signals in an overt wireless signal.

FIG. 3A shows a schematic view of a neural network architecture for an encoder of the system shown in FIG. 2B.

FIG. 3B shows a schematic view of a neural network architecture for a decoder of the system shown in FIG. 2B.

FIG. 3C shows a schematic view of a neural network architecture for a critic module of the system shown in FIG. 2B.

FIG. 4A shows a graph representing the loss function for QPSK at the training SNR.

FIG. 4B shows a graph representing the generated noise signal constellation for QPSK at the training SNR.

FIG. 4C shows a graph representing the transmitted covert signal constellation for QPSK at the training SNR.

FIG. 4D shows a graph representing the received covert signal constellation for QPSK at the training SNR.

FIG. 5A shows a graph representing the learned distribution of the system shown in FIG. 2B.

FIG. 5B shows a graph representing the confidence probability generated by the critic module for the system shown in FIG. 2B.

FIG. 6A shows a graph representing the Bit error rate for the system shown in FIG. 2B.

FIG. 6B shows a graph representing the corresponding regions of operation.

### DETAILED DESCRIPTION OF THE INVENTION

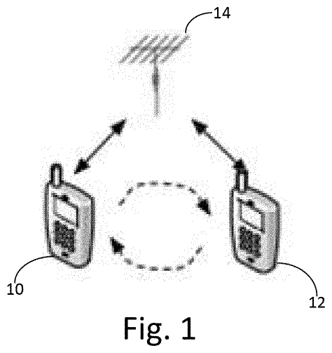

With reference to the figures in which like numerals represent like elements throughout the several views, FIG. 1 is a pictorial diagram of a high-bandwidth covert side-channel between multiple radios, transmitter radio 10 and receiver radio 12 using a common wireless network 14. The method is covert because, in one embodiment, the devices, such transmitter radio 10 and receiver radio 12 (or like laptops or smartphones) can function as normal devices using standard over-the-air communication channels that transmit overt signals. But, rather using over encrypted messaging with each other, or through or some centralized server or other device, the transmitter radio 10 and receiver radio 12 can appear to be conducting normal network communication (browsing web pages, sending mail, streaming multimedia) when, in fact, they are able to communicate undetected. An adversary will face great challenge in discovering the side channel because the covert channel(s) is being transmitted by normal mobile nodes.

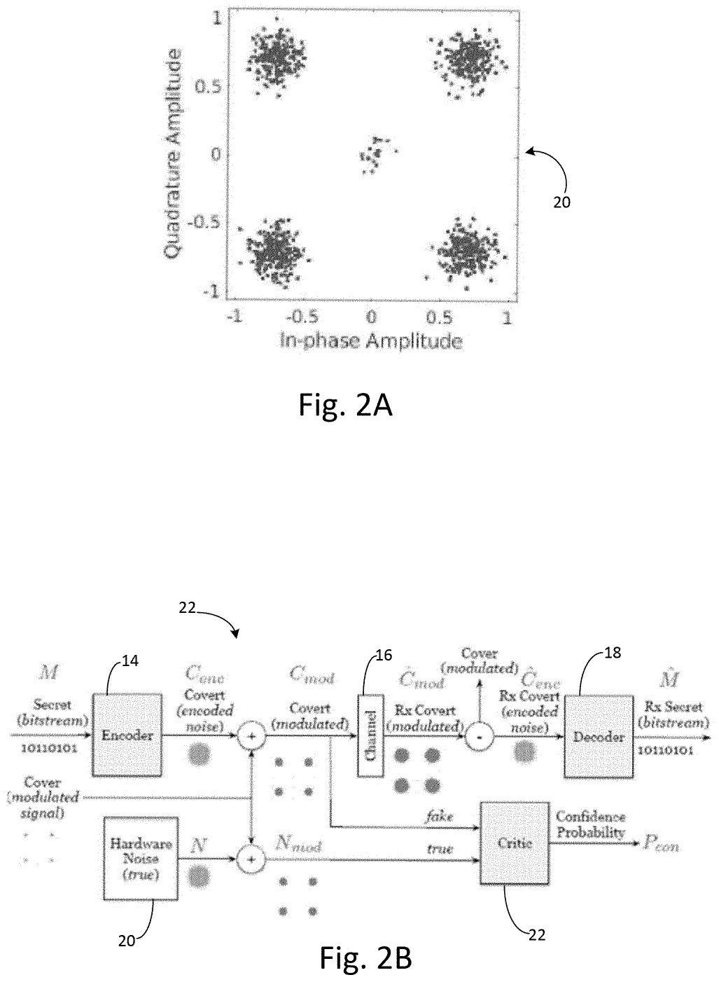

In one embodiment, the technique uses a common, physical-layer protocol to mask the communication that takes advantage of the hardware imperfections present in commodity hardware, intrinsically noisy channel of wireless communication, as well as potentially receiver diversity. When embodied within software-defined radios, the system operates in the standard 2.4 GHz ISM band, but can also be easily extended to TV or other broadcast channel whitespaces. In one embodiment, the system 22 (FIG. 2B) uses an OFDM waveform. Most consumer electronic devices use OFDM waveforms for high-bandwidth networks (including DVB, DAB, WiFi, WiMAX and LTE), and there are benefits in “hiding” in such a ubiquitous waveform. For example, imperfections in off-the-shelf Network Interface Cards (NICs), coupled with an additive random wireless channel, causes the signal to degrade over time and distance. To mask a covert communication, one can “pre-distort” the signal to mimic the normal imperfection of the hardware and Gaussian distortion arising from the channel. This distortion appears as noise to the unobservant receiver, be it the Wi-Fi access point or an adversary. However, a receiver (such as receiver radio 12) can be aware of the presence of the signal and its encoding technique can decode the “noise” to reveal the hidden message in the covert signal.

FIG. 2A shows a graph representing hardware noise, and FIG. 2B shows a schematic view of a system 22 for hiding covert signals in wireless signals. The radio frontend and analog components in the transmitting radio 10 and the receiving radio 12 radios introduce impairments, including carrier frequency offset, sampling clock offset, phase noise, IQ imbalance, DC offset and power amplifier (PA) non-linearity. In practical scenarios, a combination of these different impairments render as a noise that changes a modulated constellation point to a constellation cloud 10, as shown FIG. 2A. Wireless standards provide acceptable range of error for operation. Consequently, one can generate a covert wireless signal statistically identical distribution of hardware noise such that a steganalysis on this covert signal will not be able to differentiate whether the source of the noise is the transmitter frontend or there is an underlying covert communication.

Generative Adversarial Networks (GAN) are extant intelligent networks that can generate realistic images, videos, speech, handwritten text that efficiently transforms the domain of input data to another desired domain. The present invention can leverage this property of the GANs to transfer the domain of secret message to a hardware noise, which can be carried by any cover signal of choice. FIG. 2B shows a block diagram of the system 12 for adversarial learning, where the encoder 14 and decoder 16 network is trained in presence of a critic network (or module) 22, which acts like a steganalyzer to differentiate true hardware noise from encoder generated covert signal.

In the system 12, one or more covert wireless signals (such as QAM or OFDM digital signals) can be transmitted within an overt wireless signal (such as Wi-Fi, LTE, LoRA, or other standard communication, regulatory band signals). The encoder 14 receives a bitstream M and encodes the received bitstream (C_{enc}) into an encoded noise signal that replicates a noise signal (N) of a predetermined hardware device (Noise generator 20), such as a transmitting radio 10 or other transmitting device, such as repeater, Wi-Fi router, etc. The encoded noise signal is then combined with a cover modulated signal (C_{mod}) to form at least one covert wireless signal that is distinct from and conceals the received bitstream. The covert wireless signal is transmitted within an overt wireless signal over a channel 16 to a decoder 18 that receives the covert wireless signal (C_{mod}), removes the cover modulated signal from the received covert wireless signal to isolate the encoded noise signal (C_{enc}), and then converts the isolated encoded noise signal into a decoded bitstream (M). The decoder 18, can, but does not have to, receive the overt wireless signal and/or act upon it.

The system 12 can include a critic module 22 operably coupled to the encoder 14 that compares the encoded noise signal (C_{enc}) generated by the encoder 14 and the noise signal (N) of the predetermined hardware device, and determines statistical properties for each of the encoded noise signal and the noise signal of the predetermined hardware device. The predetermined hardware device can be any device that is known to introduce an amount of noise in a wireless signal transmission. The encoder 14 can be further configured to adjust characteristics of the encoded noise signal in response to the critic module 22 determining that the statistical properties for the encoded noise signal (C_{enc}) differ from the statistical properties of the noise signal (N) of the predetermined hardware device.

In one embodiment, each of the encoder 14 and the decoder 16 includes a multi-node neural network. Other types of AI or other expert systems can be used for each of the encoder 14 and decoder 16. In such embodiment, the encoder 14 can be further configured to transmit the original bitstream (M) to the decoder 16, or other device, for a predetermined training session such that the decoder 16 will receive the bitstream from the encoder 14 during the training session, and compare the received bitstream with the decoded bitstream to thereby determine a decoding accuracy. Thus, the network can be “trained” to ensure it is correctly recreating the covert bitstream. The decoder 16 can relay the decoding accuracy to the encoder 14 and thus train the system 12 to increase accuracy in receipt and reveal of the contents of the one or more covert wireless signals

As is further explained herein, the covert wireless signal can be a single signal within the overt channel, or can be plurality of carrier signals, optionally established through orthogonal frequency-division multiplexing (OFDM) or quadrature amplitude modulation (QAM). The covert signal(s) can also themselves be encrypted depending on the embodiment, but the encryption/decryption of the covert signals does add overhead to the data transmission, both lowering data capacity as well as increasing the possibility of detection.

Several advantages of the present invention can be categorized as: 1) Cover-independent covert signal: The proposed method to generate a covert signal by domain transformation is independent of any properties of the cover signal, like waveform or modulation order; 2) High capacity. As the covert signal is independent of the cover, one symbol of cover signal can embed one symbol of covert signal. Hence, in the domain of complex representation of signals, it can achieve up to 100% embedding capacity; 3) Hardware Noise as an input to the NN: a flexible neural network architecture can be used where the variation of hardware noise is chosen as an input parameter; 4) Steganalyzer in a training session: Instead of performing steganalysis as a separate task, the steganalyzer can be integrated during the process of encoding, in form of a critic module 22. The critic module 22 helps in differentiating true hardware noise and encoder 14 generated covert signal, thus providing important feedback to the encoder 14 for optimizing the encoding process. As the steganalysis is performed in signal domain, and not on decoded data, it is resilient to signal anomaly detection techniques; and 5) Operational in wide range of SNR: Instead of modulating symbol-by-symbol as in traditional communication system, the encoder 14 and decoder 18 are designed to operate on blocks of bits, which improves the performance of the covert link at different levels of induced hardware noise

In one embodiment, system 12 can consist of three main nodes: an encoder 14, a decoder 18 and a critic as shown in FIG. 1b. The encoder 14 encodes a confidential message M and outputs covert noise vector C_{enc} that has the same statistical properties of the transmitter's hardware impairments. In other words, C_{enc}˜C [symbol] (0,σ²_{HW}) where σ²_{HW} equals maximum constellation error (Eᵣₘₛ)(i.e. σ²_{HW}=Eᵣₘₛ) where for a given modulation order m. The encoder modulates C_{enc} using a cover signal to produce a complex modulated covert signal C_{mod}, then transmits C_{mod} over a broadcast channel.

Similar to most steganographic schemes, a distorted cover signal N_{mod} consists of a modulated cover signal added to a noise signal N. The noise signal N is collected from a real transmitter to carry the statistical properties of the transmitter's hardware impairments. In other words, N˜C [symbol] (0,σ²_{HW}). The main goal of the encoder is encoding the confidential information M to generate complex covert signal C_{mod} that looks statistically identical to a distorted cover signal N_{mod} such that any receiver can demodulate C_{mod} as a standard modulated signal. But, an intended receiver with a decoder 18 neural network, can decode it and extract the secret message, M. Thus, there can exist an AWGN channel between the encoder 14 and decoder 18. If the encoder 14 transmits a complex modulated signal C_{mod} the decoder 18 receives Ċ_{mod} which is given by: Ċ_{mod}=C_{mod}+W where W˜C [symbol] (0,σ²_{ch}) is the added noise vector due to the channel, and σ²_{ch} depends on SNR of the channel (SNR_{ch}).

The decoder 18 first demodulates the received complex modulated covert signal Ċ_{mod} as a standard modulated cover signal, which is then subtracted from Ċ_{mod} to reveal the encoded noise vector Ċ_{enc}. Then, it decodes Ċ_{enc} to recover original message M. The critic module 22 (Steganalyzer) is required to distinguish between C_{mod} and N_{mod}. It accepts C_{mod} or N_{mod} and calculates the confidence probability (P_{con}) for each sequence. The critic module 22 measures the statistical properties for both C_{mod} and N_{mod}. C_{mod} can be detected as an altered message if the two sequences C_{mod} and N_{mod} have different distribution. Thus, the encoder 14 has to modify C_{mod} so that it looks statistically similar to N_{mod}. However if P_{con}=0.5, then the encoder 14 performed well since the critic module 22 can not distinguish between C_{mod} and N_{mod}. At that point, C_{mod} can not be detected as an altered message the encoder 14 and decoder 18 has been trained to generate undetectable covert signal.

The encoder 14, decoder 18 and critic module 22 can all be neural networks with parameter θ_{E}, θ_{D}, θ_{C} respectively. The encoder 14 network is designed to accept M of length k in bits (i.e., M∈ß^{k×1}, where ß={0, 1}) and outputs covert noise C_{enc}∈C^{(k/2)×1}. For practical implementation, this is constrained with a variance less or equal to σ²_{HW}. Note that both M and C_{enc} have the same length k. The decoder 18 accepts the demodulated encoded noise vector Ċ_{enc}∈C^{(k/2)×1}, and outputs \dot{M}∈R^{k×1}. \dot{M} is restricted within the range between (0,1). At the end of a successful training process, M should converge to ß. The critic network accepts either C_{mod} and N_{mod}∈C^{(k/2)×1} and outputs P_{con}, which is restricted within the range of (0,1).

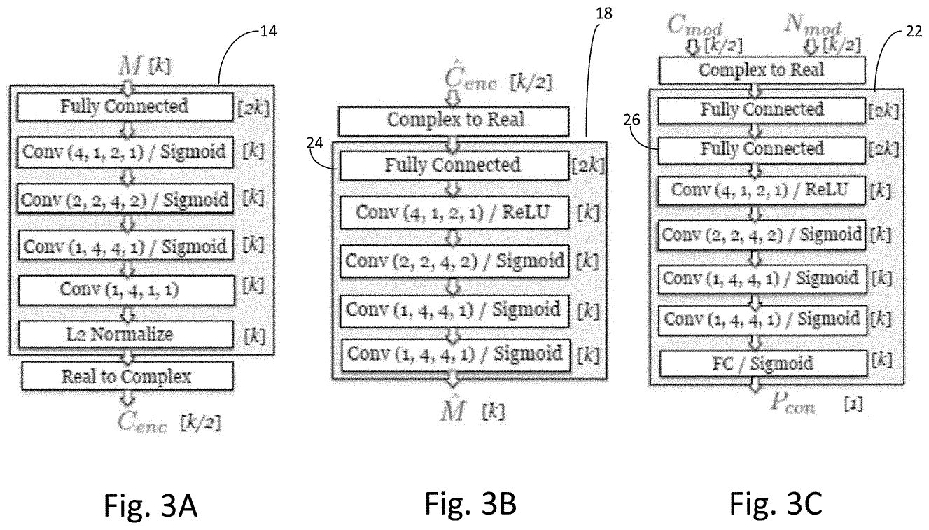

FIGS. 3A-3C show the neural network architecture for the three entities of the learning model. FIG. 3A shows a schematic view of a neural network architecture for an encoder 14 of the system shown in FIG. 2B. FIG. 3B shows a schematic view of a neural network architecture for a decoder 18 of the system shown in FIG. 2B. FIG. 3C shows a schematic view of a neural network architecture for a critic module 22 of the system shown in FIG. 2B. The encoder 14 network accepts a confidential message M, then outputs a complex noise vector. On the other side, the decoder 18 network accepts the complex demodulated signal C_{enc} and outputs the decoded confidential message M. The critic network (module 22) accepts either C_{mod} and N_{mod}, and outputs the confidence probability P_{con}.

The encoder 14 network starts with a fully connected (FC) layer 24 without any activation function. The FC layer 24 performs an initial permutation of the input data and changes the domain of the input data from bit domain to real domain to increase the mapping space and avoid singularities. The rest of the network consists of multiple convolutional layers, which extracts optimal feature representation for M. The convolutional layer, is described as Conv(W, dᵢₙ, dₒᵤₜ, s), where W is the feature window size, dᵢₙ is the input depth of the feature vector, dₒᵤₜ is the depth of the output feature vector, and s is the stride. The last layer is k-normalization to maintain C_{enc}'s power constraint. Finally, we use “real to complex” layer to merge the real output vector to a complex noise vector, C_{enc}∈C^{(k/2)×1}.

The decoder 18 network starts by “complex to real” layer to convert C_{mod} to real data vector, followed by a FC layer 24, which acts as a denoising layer to compensate the noise effect due to the channel between the transmitter and the receiver. The rest of the network consists of multiple convolutional layers to decode the encoded feature representation and obtain M. The last layer has a sigmoid activation function to restrict M's values between (0,1). After a successful training process, M should converge to the bit values. The critic network (module) 22 is similar to the decoder 18 network. However, it differs from the decoder 18 network of having an extra FC layer 26 followed by a Sigmoid activation function to output P_{con}.

The k-normalization layer is designed to constrain C_{enc}'s power level to mimic a given hardware impairment σ²_{HW}. In this work, we provide a generic design for the k-normalization layer such that it accepts as an input and can generate different levels of hardware noise as required by the system. Thus, the k-normalization layer is formulated as:

$${y}_{i} = \sqrt{\frac{k {σ}_{HW}^{2}}{2}} ⨯ \frac{{x}_{i}}{{\sum }_{l = 1}^{k} {x}_{l}^{2}}$$

where xᵢ and yᵢ are the elements of the input vector X and output vector Y respectively.

In this embodiment, the encoder 14 encodes a secret message M to produce a noise vector C_{enc} and modulated over a covert signal to produce a covert C_{mod}. The main goal of the encoder 14 to create C_{mod} that looks like a distorted modulated signal for a defined modulation order m. Moreover, C_{enc} should have the same statistical properties of the hardware noise impairments of the transmitter (e.g transmitting radio 10). The decoder 18 knows the encoding process, so it can recover the message. On the other hand, the critic network (module 22) measures the statistical properties of either C_{mod} or N_{mod} to figure out if the input signal is altered or not. In a learning-based model, the encoder 14, decoder 18, and critic module 22 can all be configured as neural networks. The encoder 14 network is trained to encode a secret message M to generate covert signals C_{mod} such that only the decoder can recover M, and the critic network (module 22) cannot do better than the random guessing between C_{mod} and N_{mod}.

One can define E(θₑ, M), D(θ_{d}, C_{mod}), C(θ_{c}, C_{mod}, N_{mod}) as the mapping functions of the encoder 14, decoder 18 and critic module 22 respectively. Moreover, we define d(M, \dot{M}) as the L2 norm between M and \dot{M}. Intuitively, the decoder's 18 loss function can be formulated as:

$${L}_{D} ( {θ}_{E} , {θ}_{D} , M ) = {E}_{M} \{ d ( M , \dot{M} ) \} = {E}_{M} \{ d ( M , D ( {θ}_{D} , E ( {θ}_{E} , M ) ) \}$$

where E_{M} {.} is the expected value over M data set. As shown, both the encoder 14 and the decoder 18 try to optimize their parameters to achieve communication reliability through minimizing the mean error between the original message M and the predicted message \dot{M}. The critic network (module 22) has the same role as the discriminator in GANs [11]. Thus, the critic's loss function can be expressed as:

$${L}_{C} ( {θ}_{C} , {θ}_{E} , M , {N}_{mod} ) = {E}_{M} \{ - log ( C ( {θ}_{C} , {N}_{mod} ) ) - log ( 1 - C ( {θ}_{C} , {C}_{mod} ) ) \} = {E}_{M} \{ - log ( C ( {θ}_{C} , {N}_{mod} ) ) - log ( 1 - C ( {θ}_{C} , E ( {θ}_{E} , M ) ) ) \}$$

L_{C} (θ_{C}, θ_{E}, M, N_{mod}) represents the binary cross entropy loss between the distorted cover N_{mod} and the covert C_{mod}, which depends on θ_{C} and θ_{E}. In this model, one can achieve the most adversarial case for the critic network (module 22) through optimizing θ_{C} using the above, which accepts the output of the encoder 14 network as an input. Thus, during the training process, one can freeze θ_{E} while updating θ_{C} to ensure that the critic network can make informed decision about distinguishing between N_{mod} and C_{mod}. As mentioned in the above discussion, the encoder should generate a covert message C_{mod} which has the same statistical properties of N_{mod}, however, the loss function presented is not normally sufficient to accomplish this property. So, a joint objective function is defined between the encoder 14 and the decoder 18 so that they can defeat the critic network (module 22) through learning an optimal transmission scheme such that the critic reaches the maximum uncertainty between N_{mod} and C_{mod}, and only the decoder 18 can recover the message. This loss function L_{E,D} can be expressed as:

L_{E,D}(θ_{E},θ_{D},θ_{E},M)=L_{D}(θ_{E},θ_{D},M)+L_{C}(θ_{C},θ_{E},M,M_{mod})

Here, the first term maintains the communication reliability between the encoder and the decoder, while the second term guarantees that the generated covert C_{mod} has the same statistical properties of the distorted cover signal N_{mod}. Similar to the critic network (module 22), both the encoder 14 and the decoder 18 update their parameters (i.e. θ_{E} and θ_{D}) based on L_{E,D} (θ_{E}, θ_{D}, θ_{E}, M) while critic's 22 parameters are frozen.

For the steganography system requirements, one can define I(X;Y) as the mutual information between X and Y. In addition, define D_{KL} (P∥Q) as the KL divergence between P and Q distributions.

For a fixed cover distribution P_{N} (n), and message distribution P_{M} (m), a steganography system having encoding and decoding functions

(ε [symbol] ) is perfectly secure, if

I(M;\hat{M})>0, and D_{KL}(P_{N}(n)∥P_{C}_{_{enc}}_{/M}(c_{enc}/m))=0

The first condition ensures the communication reliability between the transmitter (such as transmitter radio 10) and the receiver (such as receiver radio 12)(i.e., useful steganography system) while the second guarantees that the critic function (Module 22) cannot distinguish between the cover and covert messages. From previous definition, I(M,\dot{M}) is given by:

I(M̅;\hat{M})=H(M)−Ĥ(M/\hat{M})

where H (.) is the binary entropy function. The first goal of steganography system is maximizing I(M,\dot{M}). The conditional entropy H(M/\dot{M}) depends on the probability density function P(M/\dot{M}) which is given by:

$$P ( M / \text{?} ) = \frac{\text{?} ( \text{?} / \text{?} ) P ( M )}{P ( \text{?} )}$$

$$\text{?} \text{indicates text missing or illegible when filed}$$

Assuming M symbols are uniformly distributed, then we can use the likelihood approximation (i.e., P(M/\dot{M})≃P(\dot{M}/M)). Since \dot{M}=D(ε(M)), then P(\dot{M}/M) can be assumed as normal distribution with mean M and maximum acceptable variance (error) e (i.e., P(\dot{M}/M)˜ [symbol] (M,e)).

Consequently

$$max I ( M , M ) ≡ max P ( \text{?} / M ) ≡ min \frac{1}{L} {\sum }_{i = 1}^{L} {( {M}_{i} - \text{?} )}^{2}$$

$$\text{?} \text{indicates text missing or illegible when filed}$$

where L is the total number of symbols in message set. Maximizing I(M,\dot{M})) is equivalent to minimizing the mean square error between M and \dot{M}. Accordingly, the learning model satisfies the secrecy condition (i.e.,

D_{KL}(P_{N}(n)∥P_{C}_{_{enc}}_{/M}(c_{enc}/m))=0

As stated earlier, the encoder 14 and the critic network (Module 22) acts as the generator and the discriminator in a typical GAN architecture. Thus, an optimal critic network C* and be derived as:

$${C}^{*} = \frac{{P}_{N} ( n )}{{P}_{N} ( n ) + {P}_{{C}_{enc} / M} ( {c}_{enc} / m )}$$

Moreover, the optimal encoder ε* can be obtained from:

ε*=min{−log 4−2JSD(P_{C}_{_{enc}}_{/M}(c_{enc}/m)))∥P_{N}}

where JSD(P∥Q) is the Jensen-Shannon divergence between P and Q distributions. Thus, one obtains ε* if:

JSD(P_{C}_{_{enc}}_{/M}(c_{enc}/m))∥P_{N}(n))=0.

Consequently:

$$JSD ( {P}_{{C}_{enc} / M} ( {c}_{enc} / m ) ‖ {P}_{N} ( n ) ) = 0 ≡ {D}_{KL} ( {P}_{N} ( n ) ‖ {P}_{{C}_{enc} / M} ( {c}_{enc} / m ) ) = 0 ≡ {C}^{*} = \frac{1}{2}$$

Therefore, the steganography system is perfectly secure if the output of the critic network (module 22) equals ½, which means that the critic can not distinguish between the cover and covert messages, i.e.:

P_{N}(n)≃P_{C}_{_{enc}}_{/M}(c_{enc}/m)

Experimental verification of the above was performed with Tensorflow framework. The input length k=48, and the maximum relative constellation error Eᵣₘₛ values similar to 64 point FFT in OFDM PHY of WiFi standard, such that it can be used over an OFDM signal. Two training sets are constructed for the secrets M and distorted cover messages N_{mod}. Each training set consists of 20000 symbols and each symbol is of size k. The cover signal is embodied as a modulated QPSK signal (i.e., m=2). The batch size is 8000. An optimizer with a learning rate of 0.001 is used to optimize the three networks included in the learning model. The number of the training epochs is 8000. The three networks are trained simultaneously in each epoch such that the parameters of the critic network (Module 22) are updated, while the parameters of both the encoder 14 and the decoder 18 are frozen. Then, the parameters of both the encoder 14 and the decoder 18 are updated jointly while the parameters of the critic network (module 22) are frozen. The channel's training signal to noise ratio (SNRₜ) equals 17 dB. For the testing phase, a testing set consisting of 1000 symbols for M and N_{mod} were used. Then a range for SNR_{ch} was defined from 0 to 40 dB.

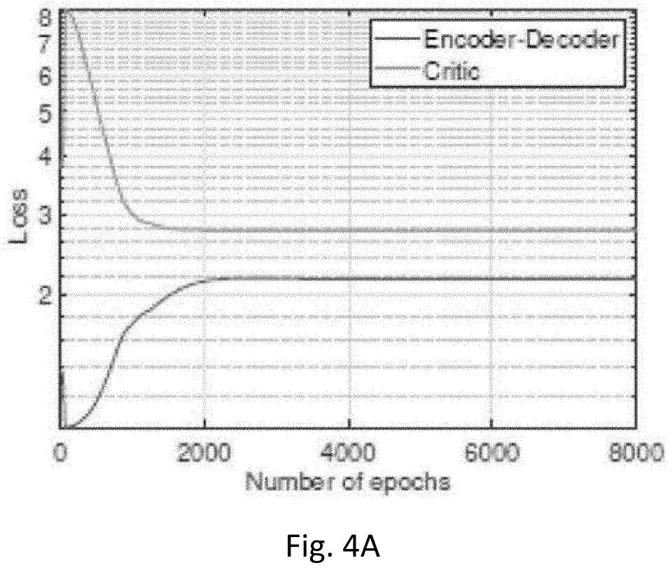

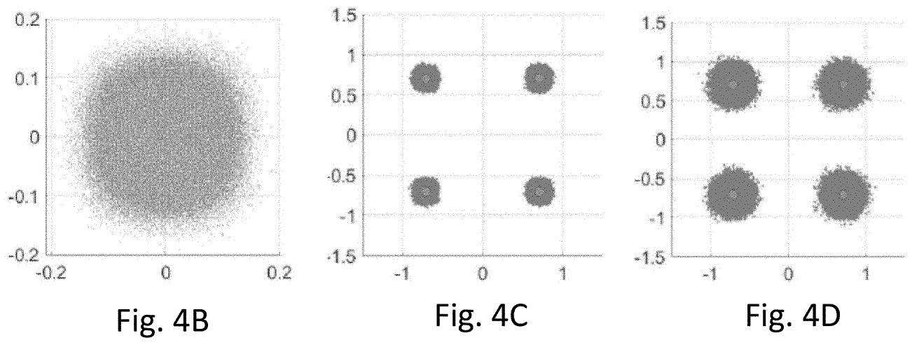

FIGS. 4A-4D show the results of a successful training process at SNRₜ and Eᵣₘₛ equals 23 db. FIG. 4A shows a graph representing the loss function for QPSK at the training SNR. FIG. 4A further shows the loss functions for both the critic network (Module 22) and the encoder 14-decoder 18. At the beginning of the training session, both the encoder 14 and the decoder 18 try to achieve only communication reliability (i.e., minimizing the error between M and \dot{M}). Consequently, the critic (module 22) loss increases, which means that the critic module 22 can distinguish between C_{mod} and N_{mod}. After some time, both the encoder 14 and the decoder 18 succeed in finding their pattern to achieve both communication reliability and signal hiding capability and defeat the critic module 22. Consequently, the critic's network (module 22) loss decreases until the critic network reaches maximum uncertainty such that it cannot distinguish between C_{mod} and N_{mod}.

FIG. 4B shows a graph representing the generated noise signal constellation for QPSK at the training SNR. FIG. 4B shows that the generated encoded noise C_{enc} constellation at the end of the training process takes the shape of circular Gaussian distribution with zero mean and a variance below Eᵣₘₛ. This result indicates that the encoder 14 succeeds in encoding M to have the same distribution similar to the hardware impairments noise vector N.

FIG. 4C shows a graph representing the transmitted covert signal constellation for QPSK at the training SNR, and FIG. 4D shows a graph representing the received covert signal constellation for QPSK at the training SNR. Note that FIG. 4C. looks like a distorted QPSK signal and the added encoded noise C_{enc} has the same statistical properties of the hardware of the hardware impairments The received covert enc impairments (i.e., C_{enc}˜C [symbol] (0,σ²_{ch})). The received covert signal constellation looks like a standard modulated QPSK signal with an added noise such that any receiver cannot infer that the signal is altered and embeds a secret message M.

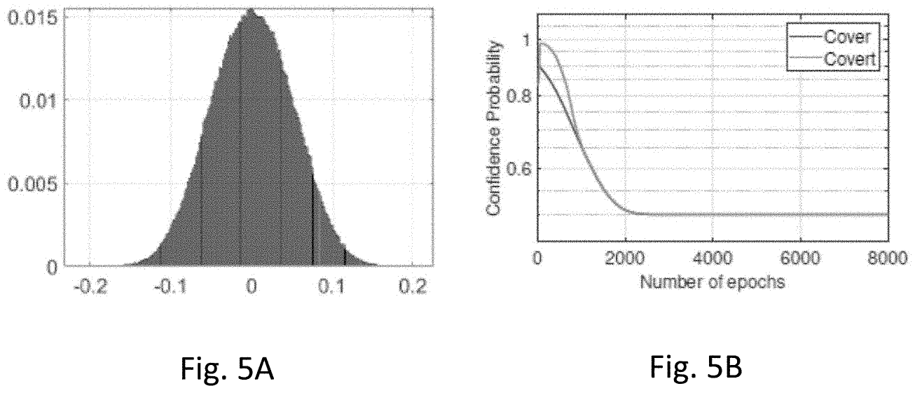

FIGS. 5A-5B show the learned C_{enc} distribution, and the score for both the cover N_{mod} and the covert C_{mod}. FIG. 5A shows a graph representing the learned distribution of the system shown in FIG. 2B. FIG. 5A shows that C_{enc}'s distribution converges to a normal distribution with zero mean and variance less than Eᵣₘₛ=−23 dB.

FIG. 5B shows a graph representing the confidence probability generated by the critic module for the system shown in FIG. 2B. FIG. 5B shows the confidence probability P_{con} for both N_{mod} and C_{mod} during the training process. At the beginning of the training process, the critic network can distinguish between the distorted cover and the covert since they took different P_{con}. At the end of the training process, we can observe that P_{con} for both C_{mod} and N_{mod} equals 0.5, reaching an optimal secrecy condition. Hence, the encoder 14 succeeded to generate a covert signal C_{mod} such that the critic network (module 22) cannot distinguish between the distorted cover and the covert message.

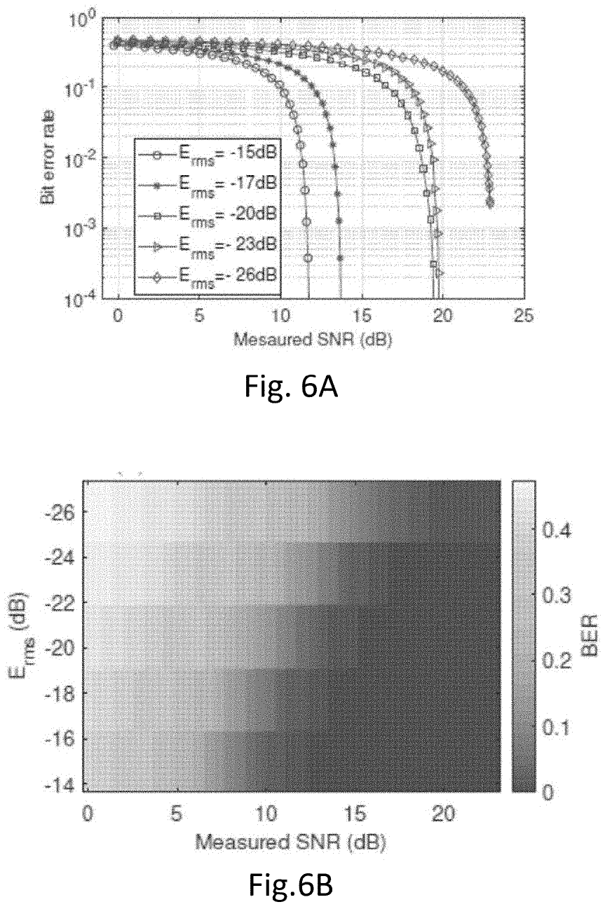

FIGS. 6A-6B show the bit error rate curves and the region of operation for different values of Eᵣₘₛ. The SNR reported here is measured at the receiver, which aggregates the effect of Eᵣₘₛ and SNR_{ch}. FIG. 6A shows a graph representing the Bit error rate for the system shown in FIG. 2B. FIG. 6A should that as Eᵣₘₛ increases, the information hiding capability increases, and the BER decreases. However, as Eᵣₘₛ increases, it has a higher effect on received signal quality compared to the channel's distortion SNR_{ch}. In other words, the communication channel between the encoder 14 and the decoder 18 requires high SNR for the covert signal to be decoded without any error. This observation can be shown directly from FIG. 5B.

FIG. 6B shows a graph representing the corresponding practical region of operation for the system such that the decoder can decode M correctly. As each bit (M) gets mapped to one real value, where two of those are combined to map in the complex domain (C_{enc}), the effective number of covert data bits that can be transmitted per IEEE 802.11a/g OFDM symbol with 48 data subcarriers is 96. Thus, an effective throughput of 12 Mbps can be achieved for covert communication at the received SNR of >12 db.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system for transmitting one or more covert wireless signals within an overt wireless signal, comprising:
an encoder configured to:
receive a bitstream;
encoding the received bitstream to an encoded noise signal, the encoded noise signal replicating a noise signal of a predetermined hardware device; and
combine a cover modulated signal with the encoded noise signal to form at least one covert wireless signal, the at least one covert wireless signal distinct from the received bitstream;
transmit the at least one covert wireless signal within an overt wireless signal; and
a decoder operably coupled to the encoder via the overt wireless signal, the decoder configured to:
receive the at least one covert wireless signal;
remove the cover modulated signal from the received at least one covert wireless signal to isolate the encoded noise signal; and
convert the isolated encoded noise signal into a decoded bitstream.

2. The system of claim 1, further comprising a critic module operably coupled to the encoder, the critic module configured to:
compare the encoded noise signal generated by the encoder and the noise signal of the predetermined hardware device; and
determine statistical properties for each of the encoded noise signal and the noise signal of the predetermined hardware device.

3. The system of claim 2, wherein the encoder is further configured to adjust characteristics of the encoded noise signal in response to the critic module determining that the statistical properties for the encoded noise signal differ from the statistical properties of the noise signal of the predetermined hardware device.

4. The system of claim 1, wherein each of the encoder and the decoder includes a multi-node neural network.

5. The system of claim 1, wherein the encoded noise signal is within a transmission bandwidth defined by at least one predetermined regulatory communication standard.

6. The system of claim 1, wherein:
the encoder further configured to transmit the bitstream to the decoder for a predetermined training session; and
the decoder further configured to:
receive the bitstream from the encoder during the training session; and
compare the received bitstream with the decoded bitstream to thereby determine a decoding accuracy.

7. The system of claim 6, wherein the decoder further configured to transmit the decoding accuracy to the encoder.

8. The system of claim 1, wherein the at least one covert wireless signal is a plurality of orthogonal frequency-division multiplexing (OFDM) carrier signals or quadrature amplitude modulation (QAM) carrier signals.

9. The system of claim 1, wherein the at least one covert wireless signal is encrypted.

10. A method for transmitting one or more covert wireless signals within an overt wireless signal, comprising:
receiving a bitstream at an encoder;
encoding the received bitstream, at the encoder, into an encoded noise signal, the encoded noise signal replicating a noise signal of a predetermined hardware device;
combining a cover modulated signal with the encoded noise signal to form at least one covert wireless signal, the at least one covert wireless signal distinct from the received bitstream;
transmitting the at least one covert wireless signal from the encoder within an overt wireless signal;
receiving the at least one covert wireless signal at a decoder;
removing, at the decoder, the cover modulated signal from the received at least one covert wireless signal to isolate the encoded noise signal; and
converting, at the decoder, the isolated encoded noise signal into a decoded bitstream.

11. The method of claim 10, further comprising:
comparing, at a critic module, the encoded noise signal generated by the encoder and the noise signal of the predetermined hardware device; and
determining statistical properties for each of the encoded noise signal and the noise signal of the predetermined hardware device.

12. The method of claim 10, further comprising:
adjusting, at the encoder, characteristics of the encoded noise signal in response to the critic module; and
determining, at the encoder, that the statistical properties for the encoded noise signal differ from the statistical properties of the noise signal of the predetermined hardware device.

13. The method of claim 10, further comprising creating a multi-node neural network at each of the encoder and the decoder.

14. The method of claim 10, wherein encoding the received bitstream, at the encoder, into to the encoded noise signal is encoding within a transmission bandwidth defined by at least one predetermined regulatory communication standard.

15. The method of claim 10, further comprising:
transmitting the bitstream from the encoder to the decoder for a predetermined training session;
receiving the bitstream at the decoder during the training session; and
comparing, at the decoder, the received bitstream with the decoded bitstream to thereby determine a decoding accuracy.

16. The method of claim 10, further including, in the at least one covert wireless signal, a plurality of orthogonal frequency-division multiplexing (OFDM) carrier signals or a plurality of quadrature amplitude modulation (QAM) carrier signals.

17. The method of claim 10, further including encrypting the at least one covert wireless signal.

18. A system for transmitting one or more covert wireless signals within an overt wireless signal, comprising:
an encoding means for:
receiving a bitstream;
encoding the received bitstream to an encoded noise signal, the encoded noise signal replicating a noise signal of a predetermined hardware device; and
combining a cover modulated signal with the encoded noise signal to form at least one covert wireless signal, the at least one covert wireless signal distinct from the received bitstream;
transmitting the at least one covert wireless signal within an overt wireless signal; and
a decoding means operably coupled to the encoding means via the overt wireless signal, the decoding the means for:
receiving the at least one covert wireless signal;
removing the cover modulated signal from the received at least one covert wireless signal to isolate the encoded noise signal; and
converting the isolated encoded noise signal into a decoded bitstream.

19. The system of claim 18, further comprising a critic means, operably coupled to the encoding means, the critic means for:
comparing the encoded noise signal generated by the encoding means and the noise signal of the predetermined hardware device; and
determining statistical properties for each of the encoded noise signal and the noise signal of the predetermined hardware device.

20. The system of claim 18, wherein:
the encoding means further transmitting the bitstream to the decoding means for a predetermined training session; and
the decoding means further:
receiving the bitstream from the encoder during the training session; and
comparing the received bitstream with the decoded bitstream to thereby determine a decoding accuracy.
